(19) United States
(12) Patent Application Publication
(10) Pub. No.: US 2005/0119353 A1
(43) Pub. Date: Jun. 2, 2005

(54) Contaminant eco-remedy and use method

(76) Inventor: Fernando A. deTorres, Ocala, FL (US)

Correspondence Address: EDWARD M. LIVINGSTON, PA, 963 TRAIL TERRACE DRIVE, NAPLES, FL, 34103, US

(21) Appl. No.: 10/989,916

(22) Filed: Nov. 16, 2004

Related U.S. Application Data
(63) Continuation-in-part of application No. 09/962,509, filed on Sep. 25, 2001.

(51) Int. Cl. B01F 3/04; A62D 3/00

(52) U.S. Cl. 516/10; 588/313

(57) ABSTRACT

A contaminant eco-remedy (1) has a colloid-active detergent with colloidal microspheres of a predetermined particle size in an alkanol amide. The alkanol amide is prepared by condensation of a predetermined vegetable fatty acid with an alkanol amine, ethanol, distilled water, and ethylene diamine tetraacetic acid in predetermined proportions. The vegetable fatty acid has a saponification value of about 271 and an acid value of about 269. The colloid-active detergent is diluted with specific concentration of water, nutrients and oxidative agents for degradation and enhanced bioremediation of organic compounds that are oxidation-reduced to non-contaminant mixtures containing nitrates, carbon dioxide, oxygen and water. From organic contaminants containing chlorine and sulphur groups, the non-contaminant mixtures may contain HCL, NACL, H₂S, and SO₃. A method for using the contaminant eco-remedy includes chemical degradation in a treatment tank (2), biodegradation by bacteria (aerobically or anaerobically) in a retention tank (6), degradation, soil flushing and bioremediation of contaminated targeted soil (15), a system tank (14) for the injection of the contaminant eco-remedy and the treated groundwater with injector tubes (17), extraction wells (20) and related circulation and handling equipment and a customized tank (28) that soil-washes organic compounds from contaminated soil with the contaminant eco-remedy to water phase eco-remediated wash waters.

### BACKGROUND OF THE INVENTION

This invention relates to remediation of environmental contamination with vegetable-fat surfactants, microorganisms, nutrients, water, oxidizing agents and growth-enhancement factors for natural degradation and bioremediation of contaminative organic compounds by oxidation-reduction reaction.

Numerous attempts to remedy environmental contamination by chemical liquids, concentrations and solids are known. None are known, however to utilize a contaminant eco-remedy having a vegetable-fat surfactant and nutrients employed with a method for enhancing microbial growth and treating contaminated environment sound and safely in a manner taught by this invention.

Examples of most-closely related known but different devices are described in the following patent documents:

| U.S. Pat. No. | Inventor | Issue Date |
|---|---|---|
| 4,865,773 | Kim, et al. | Sep. 12, 1989 |
| 6,030,467 | Leser, et al. | Feb. 29, 2000 |
| 6,060,287 | Rocha, et al. | May 09, 2000 |
| 5,618,727 | Lajoie, et al. | Apr. 08, 1997 |
| 5,376,182 | Everett, et al. | Dec. 27, 1994 |
| 4,997,313 | Gibson, et al. | Mar. 05, 1991 |
| 4,943,390 | Hayes, et al. | Jul. 24, 1990 |
| 4,835,234 | Valint, et al. | May 30, 1989 |
| 4,043,908 | Roberts, et al. | Aug. 23, 1977 |

The above Kim, et al. patent discloses a type of colloid-active detergent composition which can be used as an ingredient in the present invention. The Rocha, et al. patent taught a method for preparing biosurfactants for dislodging viscose oil accumulation from petroleum-production pipes, from tanker walls and other oil-handling structure. The Lester, et al. patent taught a method for emulsifying antiknock polymers, separating emulsion from solids and then recovering the emulsion. The Lajoie, et al. patent taught use of new strains of microorganisms to consume certain surfactants and polychlorinated biphenyls (“PCB”). The Everett, et al. patent taught sonicating contaminated soil in addition to use of a super surfactant for decontamination.

Regardless of these and other decontamination attempts, there is yet a growing concern in the world about environmental pollution with chemicals of natural or synthetic origin that are released by human activities into environment where they have an undesirable effect. The total world production of synthetic organic chemicals is estimated at more than 300-million tons a year. As a byproduct of industrial production, some 265 metric tons of hazardous waste are generated every year by 14,000 U.S. industrial plants. The U.S. Environmental Protection Agency and the Congressional Office of Technology Assessment estimate that 80 percent of this waste is disposed of in landfills, many of these wastes being toxic and persistent in the environment. A nationwide survey conducted by the EPA indicates that organic compounds are the most common environmental contaminants. Types of chemical waste found at the greatest number of sites were slightly water-soluble organics, heavy metal compounds, and hydrophobic organics. Chemicals may enter the environment directly as a result of accidents, spills during transportation, leakage from waste disposal or storage sites of industrial facilities.

Oil and fuels generally enter the environment as a result of leaking from gasoline storage tanks and associated piping and accidental spills.

Some of the contamination materials and organics are hazardous in nature. Some are known carcinogens that pose a serious threat to humans and the environment. They are not readily biodegradable and can persist on a contaminated matrix for up to twenty years. Prominent contaminants include PCB, pesticides and dioxin. These are recalcitrant organics that pose a serious threat to the environment because of chemical stability and bio-accumulation properties. They accumulate in living organisms. They can persist in air, water, soil and food.

Various treatment methods are known or have been proposed for treating contaminated environments and matrixes. Included are chemical treatments, incineration, in situ treatment, ex situ treatment, bioremediation, soil flushing, soil vapor extraction and others.

None of these systems have been sufficiently successful. For disposal of PCB, only incineration is being employed significantly. However, it is very expensive and many nations are considering abandoning the practice and many incinerators in Europe and throughout the world have been closed. There is no proven non-thermal technology that has been demonstrated to be successful in degradation of PCB cost effectively without generation of hazardous byproducts. None are environmentally safe.

This invention, however, not only provides environmentally-safe, cost-effective and reliable remediation of chemical contamination of the environment; it also can incorporate other known treatment methods cost effectively and environmentally-safe.

### SUMMARY OF THE INVENTION

Objects of patentable novelty and utility taught by this invention are to provide a contaminant eco-remedy and use method which:
provides a contaminant eco-remedy that is a biologically-safe liquid without unnatural side affects;
degrades chemically and biologically a wide range of organic compounds by decomposition of the organic contaminants, deactivation of the chemical functional groups, such as hazardous characteristic, coating properties and toxicity, oxidation-reduction in a water phase and in other phases that can be dissolved in the water phase;
eco-remedies contamination of a wide range of environments by a wide range of chemical pollutants, including, but not limited to, PCB, pesticides, chlorinated solvents, volatile organic compounds, BETX, Total Petroleum Hydrocarbons, oil, fuels, most carbon chains that are hazardous and non-hazardous and every organic compound treated to date;
is comparably inexpensive in proportion to results achievable;
can utilize strains of microorganisms (exogenous or indigenous) having a capacity to grow on the colloidal-active detergent solution;
provides selectively in situ and exo-situ bioremediation of contaminated soils, compost, land farming, natural attenuation, sediments, enhancement of phyto-bioremediation and ground water;
flushes soil;
treats contaminated landfill runoff;
solubilizes and degrades Dense Non-aqueous Phase Liquids in the water phase;
deodorizes soil;
removes contaminating fungi growth from soil, plants and other items; and
overcomes prior-art bioremediation problems of (1) inadequate concentration and distribution of oxygen, (2) inadequate concentration and distribution of water/humidity, (3) inadequate concentration and distribution of nutrients, (4) poor bioavailability of contaminants, (5) poor diffusibility of contaminants, (6) poor diffusivity of contaminants, (7) poor mobility of microorganisms, and (8) poor metabolism of microorganisms.

This invention accomplishes these and other objectives with a contaminant eco-remedy having a colloid-active detergent solution with colloidal microspheres of a predetermined particle size in an alkanol amide. The alkanol amide is prepared by condensation of a predetermined vegetable fatty acid with an alkanol amine, isooctylphenoxypolyoxyoxyethylene ethanol, distilled water, p-tert-octylphenoxypolyethoxy ethanol and etheylene diamine tetraacetic acid in predetermined proportions. The vegetable fatty acid has a saponification value of about 271 and an acid value of about 269. The colloid-active detergent is diluted with nutrients and oxidative agents for biodegradation and enhanced bioremediation of organic compounds that are oxidation-reduced to mixtures containing nitrates, carbon dioxide, oxygen and water. From organic contaminants containing chlorine and sulphur groups, the mixtures may contain HCL, NACL, H₂S, SO₃ etc. A method for using the contaminant eco-remedy includes its in situ or ex situ application with bioavailable enhancement by the eco-remedy, air and agitation predeterminedly.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a diagram of a treatment-tank method for using the present contaminant eco-remedy;

FIG. 2 is a diagram of a soil-treatment method that can include above-ground and/or in-ground bioremediation; and

FIG. 3 is a diagram of customized adaptation of the method for using the contaminant eco-remedy.

### DESCRIPTION OF PREFERRED EMBODIMENT

Listed numerically below with reference to the drawings are terms used to describe features of this invention. These terms and numbers assigned to them designate the same features throughout this description.

```
  1. Contaminant eco-remedy
  2. Treatment tank
  3. Untreated organic waste
  4. Agitator
  5. Treated organic waste
  6. Retention tank
  7. Water
  8. Bioremedied waste
  9. Disposition site
10. Air
11. Venturi nozzle
12. Pressurization source
13. Air tube
14. System tank
15. Target soil
16. Area
17. Injector tube
18. Injection orifices
19. Fluid pump
20. Monitoring well
21. Air conveyance
22. Extraction well
23. Extraction pump
24. Underground water
25. Contaminated soil
26. Pan feeder
27. Trommel screen
28. Customized tank
29. Custom agitator
30. Press
31. Water-phase eco-remedy
```

This invention provides an environmentally-safe remedy and methods for its use to degrade chemically and biologically chemical contamination of the environment and items in it. The environmentally-safe remedy is referred to herein as a contaminant eco-remedy 1.

The contaminant eco-remedy 1 is a liquid composition that includes a colloid-active detergent that is a solution with colloidal microspheres of a predetermined particle size in an alkanol amide. The particle size of the colloidal microspheres is preferably 10⁻⁵ to 10⁻⁷. The alkanol amide is prepared by condensation of a predetermined vegetable fatty acid with an alkanol amine [HOCH₂CH₂NH₂], isoocytolphenoxypolyxyethylene ethanol [(CH₃)₃CCH₂C(CH₃)₂C₆H₄O(CH₂)₂O(C₂H₄O)₇C₂H₄OH] which is a nonionic surfactant, p-tert-octylphenoxypolyethoxy ethanol [(CH₃)₃ CCH₂C(CH₃)₂C₆H₄O(CH₂CH₂O)ₓH], distilled water, and ethylene diamine tetraacetic acid in predetermined proportions.

The amount of alkanol amide is about 28-to-30% by weight; the amount of isoocytylphenoxypolyoxyethylene ethanol is about 25-to-27% by weight; the amount of distilled water is about 26-to-28% by weight; the amount of p-tert-octylphenoxypolyethoxy ethanol is about 16-to-18% by weight; and the amount of ethylene diamine tetraacetic acid is about 1% by weight.

The vegetable fatty acid has a saponification value of about 271 and an acid value of about 269. The vegetable fatty acid includes molecular polymers having predetermined structure and length characteristics for biodegradation and bioremediation of predetermined contaminants selectively. It can be a derivative of vegetable matter having fatty acids with predetermined structure and length characteristics for biodegradation and bioremediation of predetermined contaminants selectively. The vegetable matter can include soy beans, corn, coconuts, peanuts, safflower seeds, olives and other prominent sources of vegetable fat. The fatty acid of any of these vegetables is suitable, but some are more suitable than others for degradation of particular chemical contaminants. For instance, corn and coconuts yield fatty acids with longer polymers than for soy beans and olives, which causes them to be slightly less effective for degrading particularly long polymers of PCB, but slightly more effective for degrading other chemical contaminants. Selecting the vegetable fatty acid of the colloidal-active detergent for degradation and bioremediation of particular chemical contaminants can be included in the use method that includes adjusting concentration, mix and rate of conveyance of the contaminant eco-remedy 1 and compressed air to target soil selectively during a bioremediation period.

The colloid-active detergent is diluted with a specific concentration of water and predetermined nutrients and oxidative agents selected for degradation and enhanced bioremediation of organic compounds by oxidation-reduction to result in non-contaminant mixtures containing nitrates, carbon dioxide, oxygen and water. From organic contaminants containing chlorine and sulphur groups, the non-contaminant mixtures may contain HCL, NACL, H₂S and SO₃. The nutrients and oxidative agents with which the colloidal-active detergent is diluted include select fertilizers, air, oxidants and water selectively. The select fertilizers can include predetermined manure, sewage, ammonia and chemical fertilizing preparations selectively for assuring a prescription C/N/P ratio, pH factor and other prescription nutrients. The oxygen is added as air with force from an injection system, with agitation and with circulation selectively. The water also can be added with force from injection, with venturi air injection, with agitation and with circulation selectively.

Strains of microorganisms having a capacity to grow on the colloidal-active detergent can be included in the contaminant eco-remedy 1. Some new strains of microorganisms with this capacity have been developed and can be developed increasingly with rapid development of genetic engineering.

A fundamental advantage of the contaminant eco-remedy 1 is adaptivity to inclusion of a selection of relatively natural ingredients and yet have effective surfactant-detergent characteristics. This adaptivity factor includes bioavailability for bioremediation progressively and prescriptively in combination with native bacteria. It is a novel feature that renders it bioremedial effect more effectively, permanently, inexpensively and environmentally-safe.

The colloid-active detergent solution is a nutrient surfactant with extraordinary effects as a detergent mechanism. It has strong surface-action capacity without ionization. It diffuses rapidly into solution and continues random movements of colloid particles to promote complex activities that include magnetic property, electrophoresis, absorption property, surface activity, hyper wetting, penetration, emulsification and diffusion for superior detergent operation in practical use.

When the detergent mixture is dispersed in water, the detergent forms colloidal dispersant as micelles. The colloidal particles produce a complicated collision effect with surface-charged particles through mutually random reactions. In practice, water is an important factor to functionalize a characteristic deterging mechanism. The colloidal-active formulation has a very high degree of microbial decomposability. Thus, it may be decomposed substantially within a short period in the sea or rivers. Furthermore, microorganisms, even at very low temperature, may decompose this surfactant easily. The degree of microbial decomposability of the detergent solution at 25° C. is about 90% after 24 hours and 99% by weight after seven days. The micelles formation of this product can capture and dissolve relatively water insoluble contaminants.

The use of nutrient surfactants enhances the degradation of the organic compounds in the water phase. These surfactants have been extensively proven to enhance degradation of hazardous waste as described in U.S. Pat. No. 6,030,467 and in U.S. Pat. No. 2,748,080. They are amphipathic molecules consisting of a hydrophilic polar head and a hydrophobic non-polar tail group. As an advantage, these molecules can dissolve polar and non-polar substances. They tend to migrate to surfaces and to interfaces or to create a new molecular surface by forming aggregates called micelles. Also, these surfuctants can enhance organic removal by raising the solubility of the substance, making it available for degradation and facilitation of transport of the substrate across a bacteria cell membrane, in addition to formation of emulsions between two immiscible liquids.

When the contaminant eco-remedy 1 as an enhanced solution of the nutrient surfactant is created by adding nutrients, it is placed in contact with a product that includes target organic compounds having a contaminated matrix of either soil, water or free product. Water is added together with an oxidative agent, either peroxide or aeration in the water phase and the product starts an oxidation-reduction process. The product will degrade the organic compounds to nitrates, oxygen, carbon dioxide and water. When treating halogenated organic compounds that include, but are not limited to, PCB, chlorinated solvents, volatile organic compounds (VOCs), pesticides, BETX, THP, aromatic compounds and aliphatics, the product will render as one of its by-products of the degradation the corresponding hydrated halogen. It will degrade all organics in a water matrix (phase), organic matrix and soil matrix.

Bioavailability is the result of the reduction of surface tension on organic contaminants and the improvement of interfacial tension between organic compounds, water and soil for enhancing release of hydrophobic organic compounds (ITF) to the water phase. Bioavailability can be achieved by increasing partitioning of the carbon chains into the aqueous phase where bacteria population can gain access to contaminants for biodegradation. One option is addition of surface-active agents, such as surfactants, to contaminated media, which increases solubilization rates and makes a greater fraction of the contaminants amenable to biodegradation. Transfer of an organic phase to the water phase by the nutrient surfactant homogenizes a mixture of a plurality of phases into one phase. Use of this contaminant eco-remedy 1 containing this nutrient surfactant has shown that no de-emulsification process occurs at any time in contrast to high rates of de-emulsification from using other surfactants.

Microbial activity in contaminated sites can be enhanced by altering the contaminant chemically or physically to make it more conductive to natural bioremediation. This contaminant eco-remedy 1 has a C/N/P ratio that is optimized for each use and site, taking soil characteristics into consideration when the matrix is soil.

Mineralization of organic compounds can be provided by native bacteria through bioavailability of contaminants in the water phase with use of this contaminant eco-remedy 1. The organic compounds must be bioavailable in the water phase because bacteria cannot access organic carbons in the organic phase. The carbon of the organic compounds must be available in the water phase. When the contaminant or organic compounds are homogenized in the water phase of the contaminant eco-remedy 1 solution, the bacteria have access to the short carbon chains available to be degraded by them as their source of energy. The carbon chain must be in the water phase in order to be transported through bacterial cell membranes. This organic carbon must be in short chains to pass across the cell membranes.

Organic compounds are not water soluble or readily accessible in the water phase for the bacteria to degrade them. This is the reason for the use of surfactants in surfactant-aided bioremediation, in waste-water treatment plants and in other waste-treatment technologies in which the target is to emulsify the organic compounds in the water phase. Byproducts of the mineralization of organic carbons in the water phase by the bacteria include methane, carbon dioxide, nitrates and water.

The contaminant eco-remedy 1 contains a natural mixture of soaps, emulsifiers and natural hyper-wetting agents that aids in the even distribution of water molecules, nutrients and oxygen throughout a treatment zone. Also the contaminant eco-remedy 1 is hydrophilic, which helps to maintain high water concentration in a soil matrix.

Effects of colloidal gas afrons, which are foaming-effect bubbles in soil, help to solubilize the organic compounds to the water phase. This effect also helps in the solubilization of recalcitrant organics and non-aqueous phase liquids present in the treatment zone. This foaming effect tends to migrate in an upward direction from a treatment level because the product is introduced by injections wells that reach one foot below the water level delivering the contaminant eco-remedy 1 to be mixed with water that is injected at a pressure that creates a colloidal gas bubble effect. This injection is applied by compressed air that also spreads the contaminant eco-remedy 1 across a circumference of an injection well, through the vadose zone and upward and laterally to a top or discharge zone. The foam is present on all of the surface of the treatment zone. The foam aids the bioavailability by solubilization of the contaminant and the trapping of air (O₂) to achieve the following use-method objectives:
1. Creating an adequate concentration and distribution of oxygen.
2. Creating an adequate concentration and distribution of water/humidity.
3. Creating an adequate concentration and distribution of microbial nutrients.
4. Rendering a target organic contaminant bioavailable in the water phase by breaking down large molecules of hazardous compounds into small molecular chains that can be utilized by microorganisms.
5. Solubilizing the contaminant.
6. Augmenting diffusivity of contaminants.
7. Augmenting mobility of microorganisms.
8. Enhancing metabolism of the microorganisms.

For the method of using the contaminant eco-remedy 1 to treat contaminated soil, it is preferable to have a plurality of injection wells situated at strategic positions proximate a targeted area of contamination, referred to as a plume, to treat a selected volume of soil. Directed into the injection wells is an injection system that is effectively placed and provided with compressed air up to about 30 psi. Depth of the injection system in the injection wells is preferably about one foot below a water level of the targeted area to insure injection of the contaminant eco-remedy 1 into, below and above the vadose zone. The injection system includes PVC perforated fluid conveyances having perforation orifices in and along the conveyances for predetermined communication of the contaminant eco-remedy 1 to the targeted area.

Air-pressure injecting the contaminant eco-remedy 1, which includes nutrients (C/N/P ratio, O₂, humidity and pH), to soil proximate the water level creates a homogeneous mixture of the contaminant eco-remedy 1 with the water below the vadose zone. Simultaneously, it creates a foaming effect of bubble formation. This overcomes prior-art bioremediation problems of (1) inadequate concentration and distribution of oxygen, (2) inadequate concentration and distribution of water/humidity, (3) inadequate concentration and distribution of nutrients, (4) poor bioavailability of contaminants, (5) poor solubility of contaminants, (6) poor diffusivity of contaminants, (7) poor mobility of microorganisms, and (8) poor metabolism of microorganisms.

The foaming effect accumulates and rises up the vadose zone where it can be observed on the surface of the selected treatment volume of soil. After injecting a selected amount of the contaminant eco-remedy 1 into the treatment area, aeration is added on a constant basis to insure proper delivery of oxygen for microbial activity to occur. Another important aspect of the compressed air is to insure idealized contact of the contaminant eco-remedy 1 with the targeted contaminant to be degraded throughout a predetermined area.

The pressurized fluid injection can also change or redirect underground flow pattern of water as desired for effective eco-remedy and cleanup. It can be used also for hydro-geological containment of a site. The pressurized fluid also aids in formation of emulsion between the contaminant-eco-remedy treatment fluid and the target contaminant.

It is emphasized that after the organic contaminant has been emulsified with the contaminant eco-remedy 1, de-emulsification will not occur. Migration of the contaminant will not occur because it will have been degraded, bioremediated, biodegraded, cleaned up and stabilized in place by the contaminant eco-remedy 1 and the native bacteria proximate the affected area or plume. Without further contamination, native bacteria proximate the affected area or former plume of contaminant can be given better microbial conditions than existed previously by applying the contaminant eco-remedy 1 at the same time that it is applied to the affected area. This is a reversal of contamination.

Another feature of the use method to insure contact of the contaminant eco-remedy 1 with an organic contaminant is installation of a sprinkle system that can be an irrigation system on top of contaminated soil, like those used for agricultural uses, to deliver the contaminant eco-remedy 1 to soil by gravity and percolation. For this embodiment and for other soil-application embodiments, irrigation and aeration are ceased whenever the contaminant eco-remedy 1 is being applied and then resumed selectively afterwards in accordance with a predetermined treatment schedule.

Leaching pits or extraction wells can be used to collect contaminant-contact waters that are transferred to a holding tank, aerated, treated with the contaminant eco-remedy 1 and then returned by injection only to the contaminated area.

Land farming, natural attenuation of contaminants and phyto-remediation generally can be optimized by use of the contaminant eco-remedy 1 because its formulations contain a C/N/P ratio than enhances microbial activity of soil. A bioavailability effect is produced in the soil. It results in mineralization by native bacteria. For phyto-remediation, plants can absorb the treated contaminant without its toxic characteristics.

Approximately one-half of over ten-thousand known strains of bacteria are plants and the other one-half are animals. They support each other microbially in biological processes of supporting and recycling all life forms. Given a human-directed opportunity, they can accomplish exponentially what they achieve naturally. This invention provides that human-directed opportunity for bioremediation of chemical contamination.

A method for using the contaminant eco-remedy 1 includes its in situ or ex situ application with bioavailable enhancement by the eco-remedy water, air and agitation predeterminedly.

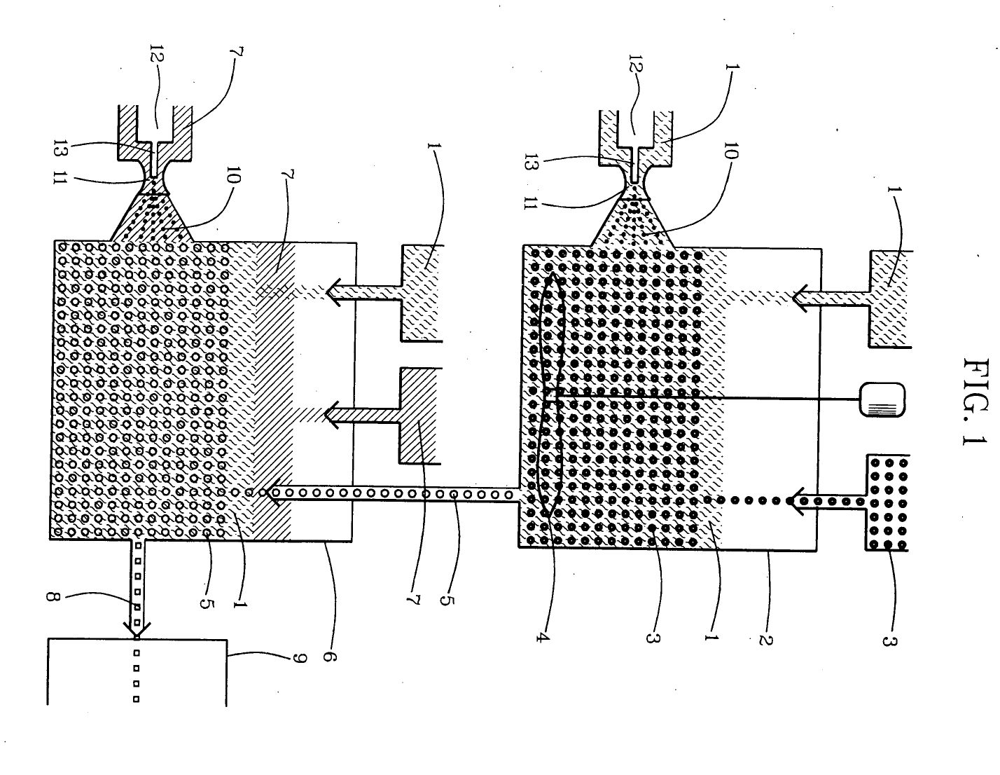

Referring to FIG. 1, for treatment-tank use, the contaminant eco-remedy 1 is put into a treatment tank 2 into which untreated organic waste 3 is then added. The untreated organic waste 3 is then contacted appropriately for the particular untreated organic waste 3 by the contaminant eco-remedy 1. Appropriate contact can include agitation with an agitator 4, circulation of the contaminant eco-remedy 1 and pressured addition of the contaminant eco-remedy 1 and/or its constituents of water, air and nutrients into the treatment tank 2.

After a prescribed treatment in the treatment tank 2, treated organic waste 5 is then transferred to a retention tank 6 where it is retained while being rinsed with water 7 and/or treated further by appropriate concentrations and/or mixes of the contaminant eco-remedy 1 to become biodegraded waste 8 that then can be transferred to a desired disposition site 9.

Untreated organic waste 3 that is aerobically biodegradable is contacted by air 10 for the prescribed treatment. Introduction of and contact by the air 10 can be accomplished by a venturi nozzle 11 in combination with enhanced contact by the contaminant eco-remedy 1 and/or in combination with enhanced contact by the water 7. With the venturi nozzle 11, the air 10 from a pressurization source 12 is released from an air tube 13 that is in line collinearly with an axis of and proximate a throat of the venturi nozzle 11 where a substance that can include the contaminant eco-remedy 1 and/or the water 7 are conveyed. The air 10 then mixes with and conveys the substance into the treatment tank 2 and/or the retention tank 6 selectively.

The untreated organic waste 3 can be solids in organic phases and/or liquids in various liquid or water phases.

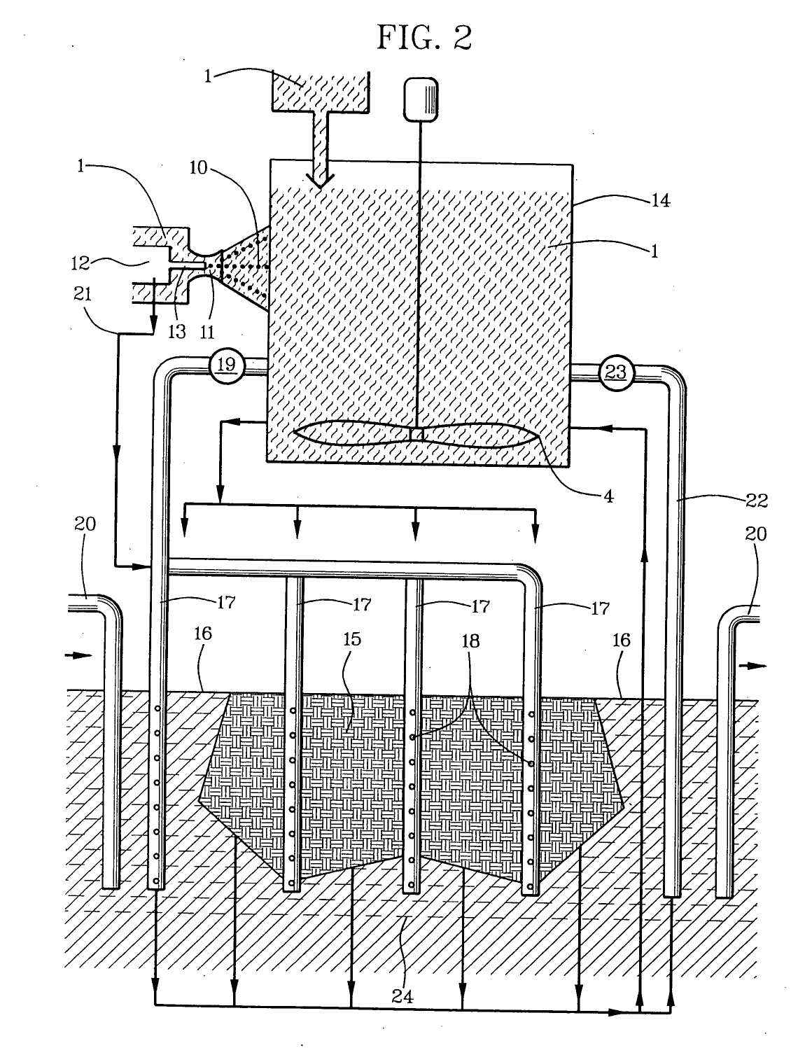

Referring to FIG. 2, for in-soil use, the contaminant eco-remedy 1 is put into a system tank 14 proximate a surface of contaminated target soil 15 in an area 16 of land. The contaminant eco-remedy 1 is injected into the contaminated target soil 15 through an injection system in fluid communication intermediate the system tank 14 and the contaminated target soil 15. The injection system includes at least one injector tube 17 extended vertically to approximately one foot below the contaminated target soil 15 or until it reaches one foot below the underground water of the site.

The injector tube 17 has a predetermined plurality and size of injection apertures 18 spaced apart for conveying the contaminant eco-remedy 1 throughout the contaminated target soil 15. The injection system can include a fluid pump 19 in fluid-pumping communication of the contaminant eco-remedy 1 to the contaminated target soil 15. The contaminant eco-remedy 1 is conveyed thereby from the system tank 14 to the contaminated target soil 15 that is treated by the contaminant eco-remedy 1 in accordance with a treatment prescription. Level of bioremediation or eco-remedy of the organic waste in the contaminated target soil 15 is tested prescriptively by sampling preferably from a monitoring well 20. Concentration, mix and rate of conveyance of the contaminant eco-remedy 1 are adjusted selectively during a bioremediation period.

For organic waste that is bioremedial aerobically, the injection system includes at least one air conveyance 21 through which the air 10 is conveyed from the pressurization source 12 to the contaminated target soil 15. Preferably, the air conveyance includes appropriately small sizes of the venturi nozzles 11 that are in pneumatic communication with the air conveyance 21 at each of the injection orifices 18. The contaminant eco-remedy 1 is then conveyed selectively as pressurized by the fluid pump 19 and/or by the air 10 through the air conveyance 21 to the injection orifices 18. This allows variation and adjustment of injection of the air 10 for aerobic and non-aerobic bioremediation.

For above-ground use of the contaminant eco-remedy 1 to accelerate and/or to replace bioremediation of organic waste in the contaminated target soil 15, an extraction well 22 that can have an extraction pump 23 is provided predeterminedly down gradient from flow of underground water 24 from the contaminated target soil 15. Underground water 14 that is contaminated from the contaminated target soil 15 is conveyed to the system tank 14 through the extraction well 22 and treated with the contaminant eco-remedy 1 prescriptively. The contaminated water is converted to treated water and conveyed to the contaminated target soil 15. Concentration, mix and rate of conveyance of the contaminant eco-remedy 1 are adjusted selectively during a bioremediation period. The underground water 24 can be recycled for further treatment as appropriate for bioremediation objectives.

Monitoring wells 20 can be positioned both down gradient and up gradient from the contaminated target soil 15, not only for bracket-testing the underground water 24, but also for flushing the contaminated target soil 15 with another concentration of the contaminant eco-remedy different than the one used for bioremediation, added up-gradient and removed down-gradient.

Above-ground soil flushing and in-soil bioremediation methods can both be employed for select contaminated target soils 15. They can employ the same hardware and use methods, except for differences related to concentrations of contaminant eco-remedy 1 and ingredients, extraction and recycling for above-ground flushing and in situ bioremediation.

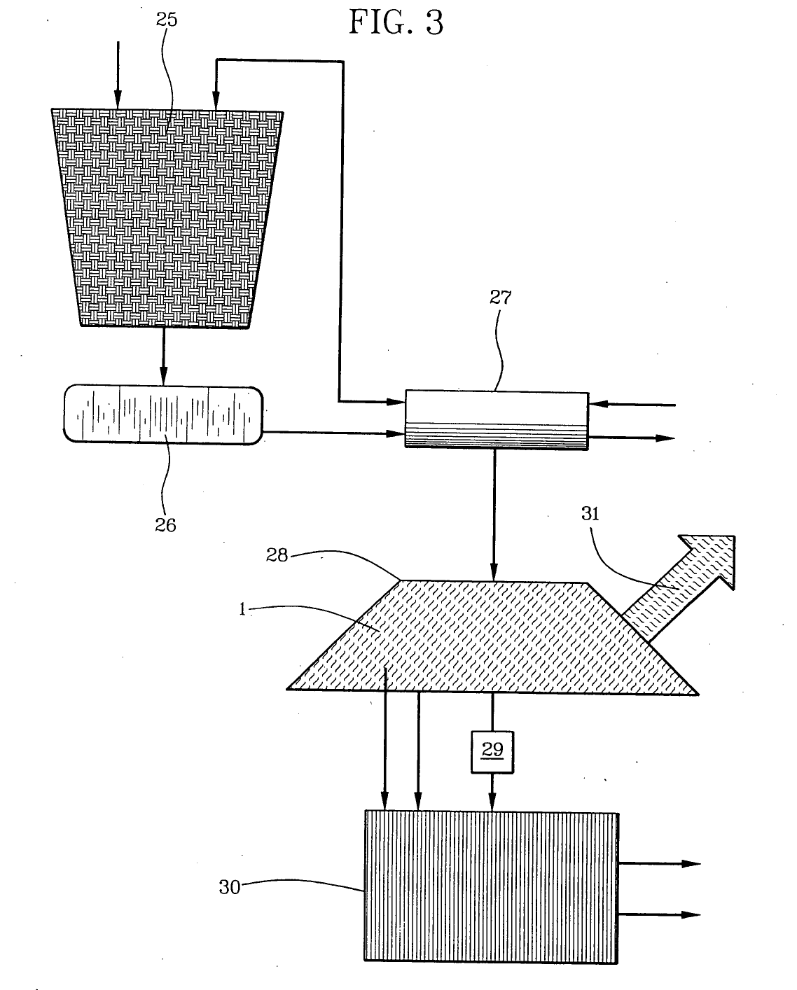

Referring to FIG. 3, special organic waste from contaminated soil 25 can be pan-fed with a pan feeder 26 to a trommel screen 27 where it is screened for special processing and then transferred to a customized tank 28 of the contaminant eco-remedy 1. The use method can employ a custom agitator 29 and a press 30 for handling special sizes and shapes of the contaminated organic waste. A water-phase eco-remedy 31 is derived from adaptations of the use method.

A new and useful contaminant eco-remedy and use methods having been described, all such foreseeable modifications, adaptations, substitutions of equivalents, mathematical possibilities of combinations of parts, pluralities of parts, applications and forms thereof as described by the following claims and not precluded by prior art are included in this invention.

1-32. (canceled)

33. The contaminant eco-remedy, comprising:
a colloidal-active solution;
the colloidal-active solution being diluted with water and at least one oxidative agent predeterminedly;
the colloidal-active solution being mixed with compressed air prior to injection into an organic contaminant; and
wherein the colloidal-active solution interacts with the organic contaminant for chemical degradation of organic compounds by reduction-oxidation into non-contaminant mixtures.

34. The contaminant eco-remedy of claim 33 wherein:
the compressed air has a pressure in pounds per square inch in the range of 40-to-60.

35. The contaminant eco-remedy of claim 33 wherein:
the at least one oxidative agent includes hydrogen peroxide (H₂O₂).

36. The contaminant eco-remedy of claim 33 wherein the colloidal-active solution contains colloidal microspheres having an average particle size of about 10⁻⁵ cm-to-10⁻⁷ cm.

37. The contaminant eco-remedy of claim 33 wherein the compressed air is added with force, agitation and circulation selectively.

38. A method comprising the following steps for chemical degradation of organic waste in a treatment tank using a contaminant eco-remedy comprising a colloidal-active solution; the colloidal-active solution being diluted with water and at least one oxidative agent predeterminedly; the colloidal-active solution being mixed with compressed air prior to injection into an organic contaminant; and wherein the colloidal-active solution interacts with the organic contaminant for chemical degradation of organic compounds by reduction-oxidation into non-contaminant mixtures, said method comprising the steps of:
putting the contaminant eco-remedy in the treatment tank;
putting the organic waste in the treatment tank;
contacting the organic waste with the contaminant eco-remedy selectively;
injecting compressed air into the treatment tank until the organic waste is degraded;
holding the organic waste in the treatment tank for a period of time required for degradation of the organic waste selectively;
transferring the organic waste from the treatment tank to a retention tank;
contacting the organic waste with water in the retention tank;
holding the organic waste in the retention tank for a retention time required for chemical degradation by oxygen reduction;
transferring the bioremediated waste from the retention tank to a desired disposition site.

39. A method comprising the following steps for chemical degradation of organic waste in soil using a contaminant eco-remedy comprising a colloidal-active solution; the colloidal-active solution being diluted with water and oxidative agents predeterminedly; the colloidal-active solution being mixed with compressed air prior to injection into an organic contaminant; and wherein the colloidal-active solution interacts with the organic contaminant for chemical degradation of organic compounds by reduction-oxidation into non-contaminant mixtures, said method comprising the steps of:
providing a system tank proximate a surface of a target soil having organic waste in an area of land;
putting the contaminant eco-remedy in the system tank;
providing an injection system in fluid communication intermediate the system tank and the target soil;
the injection system including at least one injector tube extended vertically to one of a location approximately one foot below the target soil or an underground water level in the area of land;
the injector tube having a predetermined plurality and size of injection apertures spaced apart for conveying the contaminant eco-remedy throughout the contaminated target soil predeterminedly;
the injection system including a fluid pump in fluid-pumping communication of the contaminant eco-remedy to the contaminated target soil;
conveying the contaminant eco-remedy from the system tank to the contaminated target soil;
injecting compressed air into the contaminated target soil;
testing level of eco-remedy of the organic waste in the target soil; and
adjusting concentration, mix and rate of conveyance of the contaminant eco-remedy to the target soil selectively during a chemical degradation period.

40. The contaminant eco-remedy of claim 1 wherein the organic contaminant is PCB.

41. The contaminant eco-remedy of claim 40 further comprising a solvent to aid in the breakdown of the PCB.

42. The contaminant eco-remedy of claim 41 wherein the solvent is diesel fuel.

43. A method comprising the following steps for chemical degradation of a PCB in a treatment tank using a contaminant eco-remedy comprising a colloidal-active solution; the colloidal-active solution being diluted with water and at least one oxidative agent predeterminedly; the colloidal-active solution being mixed with compressed air prior to injection into an organic contaminant; a solvent from a group of solvents which includes diesel fuel; and wherein the colloidal-active solution interacts with the organic contaminant for chemical degradation of organic compounds by reduction-oxidation into non-contaminant mixtures, said method comprising the steps of:
putting the contaminant eco-remedy in the treatment tank;
putting the organic waste containing PCB in the treatment tank;
contacting the organic waste containing PCB with the contaminant eco-remedy selectively;
injecting compressed air into the treatment tank during degradation of the organic waste;
holding the organic waste containing PCB in the treatment tank for a period of time required for degradation of the organic waste selectively;
transferring the organic waste containing PCB from the treatment tank to a retention tank;
contacting the organic waste with water in the retention tank;
holding the organic waste containing PCB in the retention tank for a retention time required for chemical degradation by oxygen reduction;
transferring the bioremediated waste from the retention tank to a desired disposition site.

44. A method comprising the following steps for chemical degradation of organic waste containing PCB in a soil using a contaminant eco-remedy comprising a colloidal-active solution; the colloidal-active solution being diluted with water and at least one oxidative agent predeterminedly; the colloidal-active solution being mixed with compressed air prior to injection into an organic contaminant; a solvent from a group of solvents which include diesel fuel; and
providing a system tank proximate a surface of a target soil having organic waste in an area of land;
putting the contaminant eco-remedy in the system tank;
providing an injection system in fluid communication intermediate the system tank and the target soil;
the injection system including at least one injector tube extended vertically to one of a location approximately one foot below the target soil or an underground water level in the area of land;
the injector tube having a predetermined plurality and size of injection apertures spaced apart for conveying the contaminant eco-remedy throughout the contaminated target soil predeterminedly;
the injection system including a fluid pump in fluid-pumping communication of the contaminant eco-remedy to the contaminated target soil;
conveying the contaminant eco-remedy from the system tank to the contaminated target soil;
injecting compressed air into the contaminated target soil;
testing level of eco-remedy of the organic waste in the target soil; and
adjusting concentration, mix and rate of conveyance of the contaminant eco-remedy to the target soil selectively during a chemical degradation period.
